(19) United States
(12) Patent Application Publication
(10) Pub. No.: US 2025/0003783 A1
(43) Pub. Date: Jan. 2, 2025

(54) COCKTAIL MAKING DEVICE AND METHOD FOR MAKING A COCKTAIL

(71) Applicant: Michael Nicolos, Elk Grove, CA (US)

(72) Inventor: Michael Nicolos, Elk Grove, CA (US)

(21) Appl. No.: 18/753,377

(22) Filed: Jun. 25, 2024

Related U.S. Application Data
(60) Provisional application No. 63/523,987, filed on Jun. 29, 2023.

(51) Int. Cl. G01F 19/00

(52) U.S. Cl. CPC G01F 19/00

(57) ABSTRACT

A cocktail making device that combines one or more recipes for a respective cocktail as well as the measurements into one product that is easy to clean. The cocktail making device includes a base cube, a top cavity, one or more first side cavities, and one or more second side cavities. The ingredient poured into the top cavity is printed on a surface of the cocktail making device for added convenience. The top cavity includes a pour spout disposed on each corner of the top cavity to facilitate ease of pouring the ingredient out of the top cavity. There is also a corresponding method for making a cocktail with the cocktail making device.

### CROSS-REFERENCE TO RELATED APPLICATIONS

This is a U.S. Non-Provisional patent application that claims the benefit of co-pending U.S. Provisional Patent Application No. 63/523,987, filed Jul. 29, 2023, which is incorporated herein by reference in its entirety.

### FIELD OF THE INVENTION

The present disclosure relates to a cocktail making device and, more particularly, to a cocktail making device and method for making a cocktail.

### BACKGROUND OF THE INVENTION

Cocktails at home are difficult to make, especially for a single serving. One must use a series of measuring cups or pay special attention when pouring to ensure the correct ratio of ingredients. Looking-up cocktail recipes and then finding the correct measuring cups is a time-consuming process and takes great attention to detail when pouring.

What is needed is a cocktail making device that combines one or more recipes for a respective cocktail as well as the measurements into one product that is easy to clean.

### BRIEF SUMMARY OF THE INVENTION

The invention itself and manner in which it may be made and used may be better understood after a review of the following description, taken in connection with the accompanying figures.

A cocktail making device, comprising a base cube including a top surface, a front surface, a first side surface, a back surface, a second side surface, and a top cavity disposed on the top surface of the base cube, wherein the front surface of the base cube includes the name of the cocktail, an ingredients list, and a plurality of instructions on how to make the cocktail with the base cube, one or more first side cavities each having a measured cavity that is shaped to contain a predetermined volume of one of the ingredients poured into one or more of the first side cavities that corresponds to a recipe to make the name of the cocktail, and one or more second side cavities each including an ingredient poured into the one or more first side cavities that is printed above the one or more first side cavities for added convenience.

The cocktail making device also includes a corresponding method for making a cocktail, comprising the steps of having each of a plurality of cavities of a base cube precisely measured, obtaining a plurality of ingredients listed on the base cube, pouring the ingredients into each of a plurality of appropriate cavities corresponding to the cavities of a base cube, depositing the ingredients into a container after each pour, and shaking, stirring or layering all the ingredients after they have been poured into the container.

It is an object of the present invention to provide a cocktail making device that gathers and organizes a plurality of cocktail recipe ingredients.

It is an object of the present invention to provide a cocktail making device that pours a plurality of individual cocktail ingredients into a plurality of cube cavities next to each cocktail ingredient's name disposed on a base cube.

It is an object of the present invention to provide a cocktail making device that combines a plurality of measured ingredients into a container.

### BRIEF DESCRIPTION OF DRAWINGS

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 shows an overhead perspective view of a cocktail making device.

FIG. 2 shows a front perspective view of the cocktail making device.

FIG. 3 shows a first side perspective view of the cocktail making device.

FIG. 4 shows a second side perspective view of the cocktail making device.

FIG. 5 shows a rear perspective view of the cocktail making device.

FIG. 6 shows a flowchart of a method for making a cocktail with the cocktail making device.

### DETAILED DESCRIPTION OF THE INVENTION

The non-limiting exemplary embodiment(s) will now be described more fully hereinafter with reference to the accompanying drawings, in which a preferred embodiment of the disclosure is shown. Such exemplary embodiment(s) may, however, be embodied in many different forms and should not be construed as limited to the embodiment set forth herein. Rather, these embodiment(s) are provided so that this application will be thorough and complete, and will fully convey the true scope of the disclosure to those skilled in the art.

The below disclosed subject matter is to be considered illustrative, and not restrictive, and any appended claim(s) are intended to cover all such modifications, enhancements, and other embodiment(s) which fall within the true scope of the non-limiting exemplary embodiment(s). Thus, to the maximum extent allowed by law, the scope of the non-limiting exemplary embodiment(s) is to be determined by the broadest permissible interpretation of the claim(s) and their equivalents, and shall not be restricted or limited by the foregoing detailed description.

References in the specification to “an exemplary embodiment”, “an embodiment”, “a preferred embodiment”, “an alternative embodiment”, and similar phrases mean that a particular feature, structure, or characteristic described in connection with the embodiment(s) is included in at least an embodiment of the disclosure. The appearances of the phrase “a non-limiting exemplary embodiment” in various places in the specification are not necessarily all meant to refer to the same embodiment.

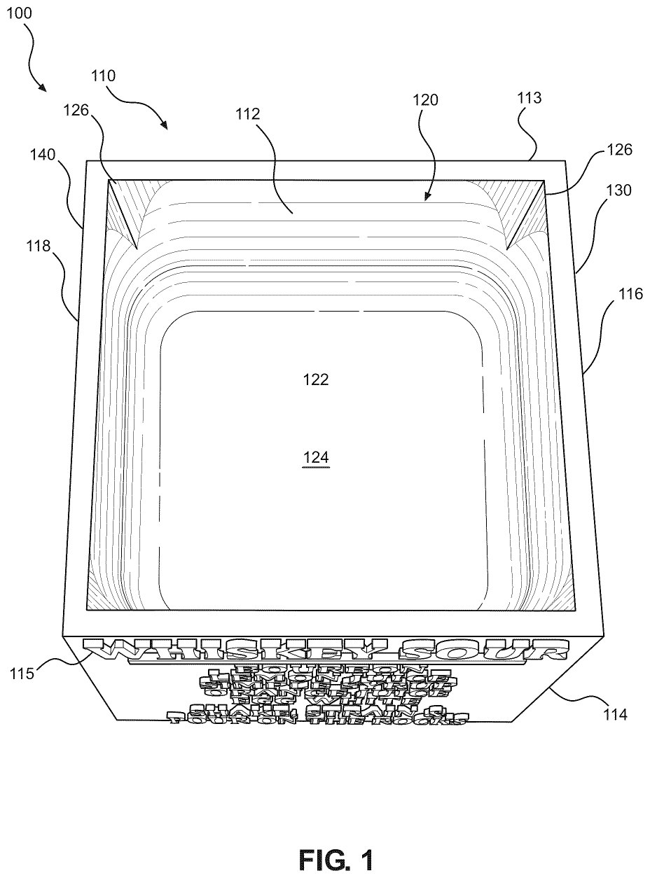

FIG. 1 shows an overhead perspective view of a cocktail making device 100.

The cocktail making device 100 may include a base cube 110, a top cavity 120, one or more first side cavities 130, one or more second side cavities 140, and a back cavity 150.

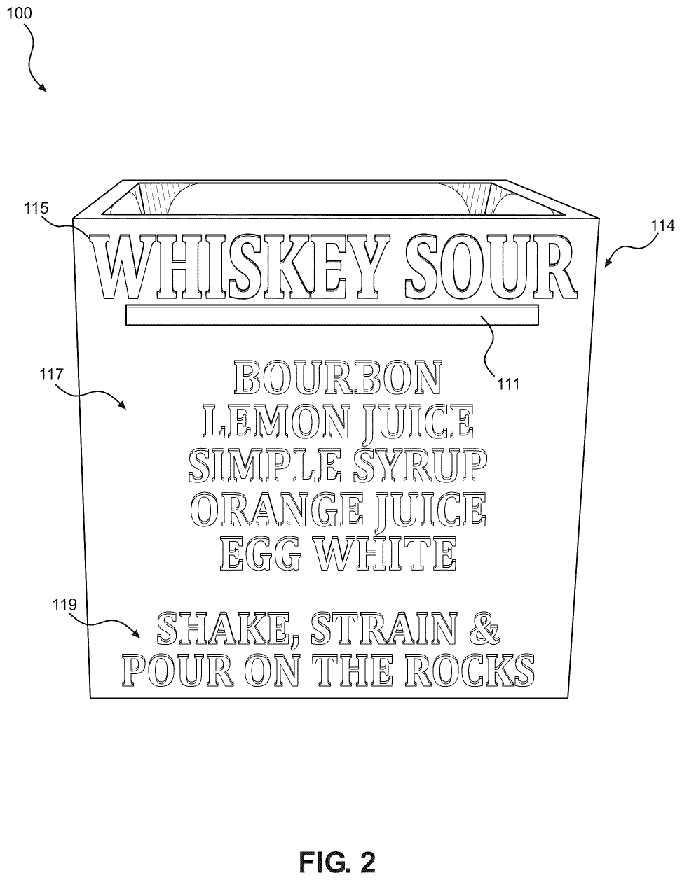

The base cube 110 may include a top surface 112, a front surface 114, a first side surface 116, a second side surface 118, a back surface 113, and a name of the cocktail (See FIG. 2, 115) being made by the base cube 110.

The top surface 112, a front surface 114, a first side surface 116, a second side surface 118, a back surface 113 of the base cube 110 may be a relatively flat surface or the like.

The top cavity 120 may be disposed on the top surface 112 or the like and is a measured cavity that is shaped to contain a predetermined volume of one of the ingredients 122 poured into the top cavity 120 that corresponds to a recipe to make the name of the cocktail 115. The ingredient 122 poured into the top cavity 120 may be printed on a bottom surface 124 of the top cavity 120 for added convenience. The top cavity 120 may include a pour spout 126 disposed on each corner of the top cavity 120 to facilitate ease of pouring the ingredient 122 out of the top cavity 120.

FIG. 2 shows a front perspective view of a cocktail making device 100.

The front surface 114 of the base cube 110 may include the name of the cocktail 115, an ingredients list 117, and a plurality of instructions 119 on how to make the cocktail 115 with the base cube 110.

The instructions 119 may be separated from the name of the cocktail 115 with a solid bar line 111 disposed between the instructions and the name of the cocktail 115 for further easy understanding of the instructions 119. The ingredient of the cocktail 115 may be written with a plurality of food grade or non-food grade ink 115A or the like.

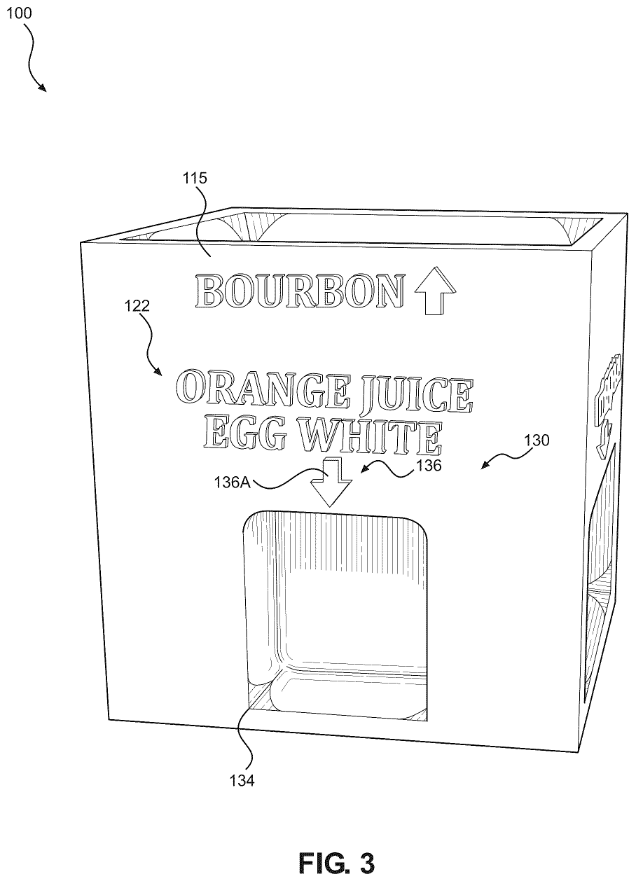

FIG. 3 shows a first side perspective view of a cocktail making device 100.

The one or more first side cavities 130 may each be a measured cavity that is shaped to contain a predetermined volume of one of the ingredients 122 poured into one or more first side cavities 130 that corresponds to a recipe to make the name of the cocktail 115. FIG. 3 shows the one or more first side cavities 130 that may each include an ingredient 122 poured into the one or more first side cavities 130 that may be printed above the one or more first side cavities 130 for added convenience. The one or more first side cavities 130 may include a pour spout 134 disposed on each corner of the one or more first side cavities 130 to facilitate ease of pouring the ingredient 122 out of the one or more first side cavities 130.

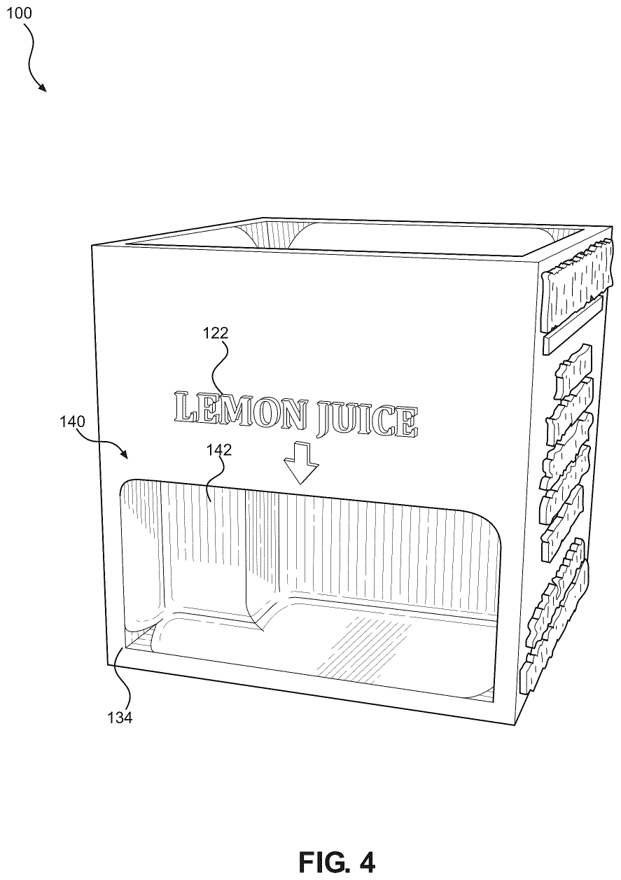

The one or more first side cavities 130 may also include a functional indicia 136, such as an arrow 136A or the like for decoration or instruction. FIG. 4 shows a second side perspective view of a cocktail making device 100.

The one or more second side cavities 140 may include a first elongated horizontal cavity 142. The one or more second side cavities 140 may each include an ingredient 122 poured into the one or more second side cavities 140 that may be printed above the one or more second side cavities 140 for added convenience. The one or more second side cavities 140 may each include a pour spout 134 disposed on each bottom corner of the one or more second side cavities 140 to facilitate ease of pouring the ingredient 122 out of the one or more second side cavities 140.

The one or more second side cavities 140 may also include the name of the cocktail (FIG. 1, 115) for further clarification.

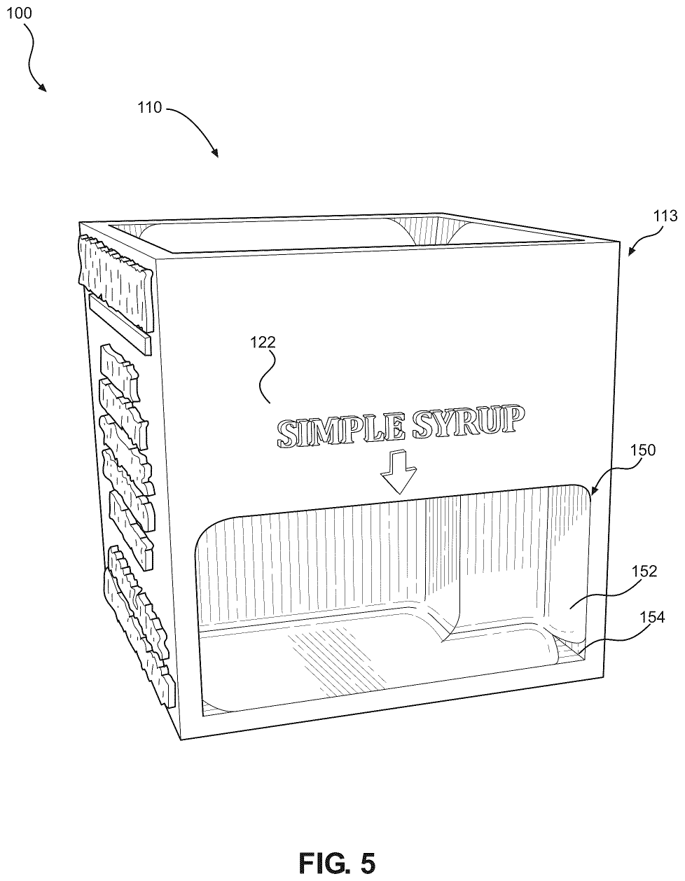

FIG. 5 shows a rear perspective view of the cocktail making device 100.

The cocktail making device 100 may include the back surface 113.

The back surface 113 may include the back cavity (FIG. 1, 150) disposed on the back surface 113 of the base cube 110. The back cavity 150 may include a second elongated horizontal cavity 152. The back cavity 150 may each include an ingredient 122 poured into the back cavity 150 that may be printed above the back cavity 150 for added convenience. The back cavity 150 may each include a pour spout 154 disposed on each bottom corner of the back cavity 150 to facilitate ease of pouring the ingredient 122 out of the back cavity 150.

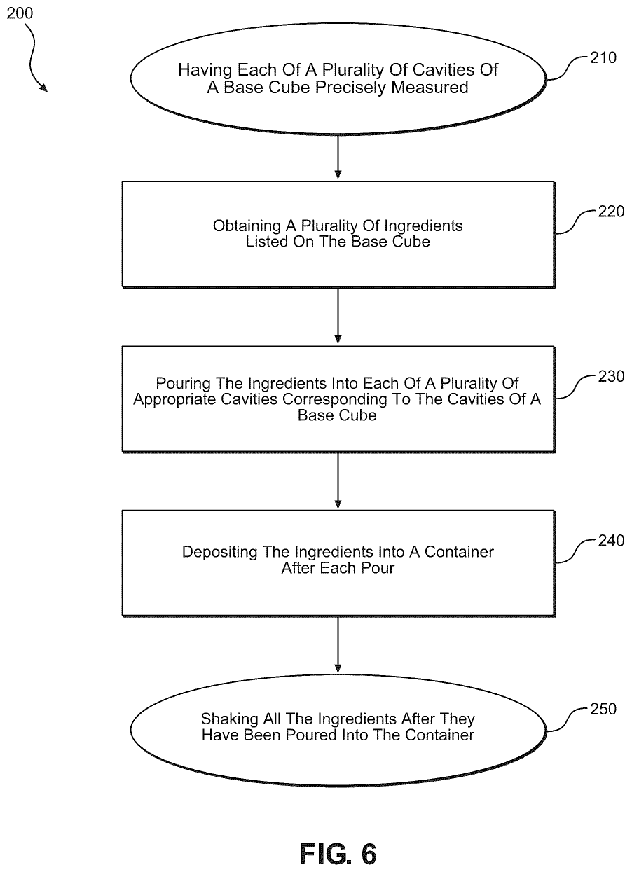

FIG. 6 shows a flowchart of a method for making a cocktail with the cocktail making device 200.

The overall method 200 may include the steps of having each of a plurality of cavities of a base cube precisely measured 210, obtaining a plurality of ingredients listed on the base cube 220, pouring the ingredients into each of a plurality of appropriate cavities corresponding to the cavities of a base cube 230, depositing the ingredients into a container after each pour 240, and shaking, stirring or layering all the ingredients after they have been poured into the container 250.

The having step 210 may ensure a correct ratio for all of the cocktail ingredients. The obtaining step 220 may include where the ingredients are listed on a front portion of the base cube. The pouring step 230 may include the appropriate cavities are adjacent to an ingredient label. The depositing step 240 may include any of the ingredients being deposited into a container after each pour. The shaking step 250 may optionally add a plurality of ice to the container resulting in a relatively cold crafted cocktail.

The cocktail making device 100 may be made with a three-dimensional or 3D printer with a converted Standard Triangle Language or STL file, an Object File Format file or an OBJ file, a Standard for the Exchange of Product Data or STEP file, or injection mold in the manufacturing process. The cocktail making device 100 may be made with an Ultraviolet and Light-Emitting Diode or UV/LED printer or the like. All of the elements to this base cube 110 are necessary to ensure proper use and may be changed based on a desired cocktail to be made. Size of the measured cavities 120, 130, and 140 and location of the measured cavities 120, 130, and 140 and each of the ingredients 122 may be changed for different cocktail creations.

If an individual person wanted to make a cocktail, the individual person would be able to use the cocktail making device 100 and follow the instructions 119 to do so. First, gather the ingredients 122 listed on the base cube 110 and pour each of the ingredients 122 into the measured cavities 120, 130, and 140 into a container or the like and enjoy.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention

What is claimed as new is:

1. A cocktail making device, comprising:
a base cube including a top surface, a front surface, a first side surface, a back surface, and a second side surface;
a top cavity disposed on the top surface of the base cube;
wherein the front surface of the base cube includes a name of the cocktail, an ingredients list, and a plurality of instructions on how to make the name of the cocktail with the base cube;
one or more first side cavities each having a measured cavity that is shaped to contain a predetermined volume of one of the ingredients poured into one or more of the first side cavities that corresponds to a recipe to make the name of the cocktail;
one or more second side cavities each including an ingredient poured into the one or more first side cavities that is printed above the one or more first side cavities for added convenience; and
a back cavity disposed on the back surface of the base cube, the back cavity includes a second elongated horizontal cavity having an ingredient poured into the back cavity.

2. The cocktail making device, according to claim 1, wherein the base cube includes the name of the cocktail being made disposed on the base cube.

3. The cocktail making device, according to claim 2, wherein the top cavity is a measured cavity that is shaped to contain a predetermined volume of one of the ingredients poured into the top cavity that corresponds to a recipe to make the name of the cocktail.

4. The cocktail making device, according to claim 1, wherein the one of the ingredients poured into the top cavity is printed on the back of the base cube for added convenience.

5. The cocktail making device, according to claim 1, wherein the top cavity includes a pour spout disposed on each corner of the top cavity to facilitate ease of pouring one of the ingredients out of the top cavity.

6. The cocktail making device, according to claim 1, wherein the one or more first side cavities, the one or more second side cavities, and the back cavity may include an arrow pointing a direction to pour the ingredients into.

7. The cocktail making device, according to claim 1, wherein the instructions are separated from the name of the cocktail with a solid bar line disposed between the instructions and the name of the cocktail to facilitate understanding of the instructions.

8. The cocktail making device, according to claim 1, wherein the one or more first side cavities include a pour spout disposed on each corner of the one or more first side cavities to facilitate ease of pouring the ingredient out of the one or more first side cavities.

9. The cocktail making device, according to claim 1, wherein the ingredient poured into the back cavity is printed above the back cavity for added convenience.

10. The cocktail making device, according to claim 1, wherein the one or more second side cavities include an elongated horizontal cavity.

11. The cocktail making device, according to claim 1, wherein the one or more second side cavities each include an ingredient poured into the one or more second side cavities that are printed above the one or more second side cavities for added convenience.

12. The cocktail making device, according to claim 1, wherein the one or more second side cavities each include a pour spout disposed on each bottom corner of the one or more second side cavities to facilitate ease of pouring the ingredient out of the one or more second side cavities.

13. The cocktail making device, according to claim 1, wherein the one or more second side cavities include the name of the cocktail for further clarification.

14. The cocktail making device, according to claim 1, wherein the cocktail making device is made with a process selected from the group consisting of a three-dimensional printer with a converted Standard Triangle Language or STL file, an OBJ file, an injection mold, or an UV/LED printer.

15. The cocktail making device, according to claim 1, wherein each of the ingredients of the cocktail is written with a plurality of food grade or non-food grade ink and the base cube may be machined, steel milled, or injection molded.

16. A method for making a cocktail with a cocktail making device, comprising the steps of:
having each of a plurality of cavities of a base cube precisely measured;
obtaining a plurality of ingredients listed on the base cube;
pouring the ingredients into each of a plurality of appropriate cavities corresponding to the cavities of a base cube;
depositing the ingredients into a container after each pour; and
shaking or stirring all the ingredients after they have been poured into the container.

17. The method according to claim 16, wherein the having step ensures a correct ratio for all of the cocktail ingredients.

18. The method according to claim 16, wherein the obtaining step includes where the ingredients are listed on a front portion of the base cube.

19. The method according to claim 16, wherein the pouring step includes the appropriate cavities are adjacent to an ingredient label.

20. The method according to claim 16, wherein the shaking stirring or layering step, optionally adds a plurality of ice to the container resulting in a cold crafted cocktail.
